(19) United States
(12) Patent Application Publication
(10) Pub. No.: US 2019/0020698 A1
(43) Pub. Date: Jan. 17, 2019

(54) Collaborative Platform for Communication, Application Development and Use

(71) Applicant: Doky Inc., Palo Alto, CA (US)

(72) Inventor: Francesco TRIPEPI, Mountain View, CA (US)

(21) Appl. No.: 16/069,838

(22) PCT Filed: Jan. 13, 2017
(86) PCT No.: PCT/US2017/013547

§ 371 Date: Jul. 12, 2018

Related U.S. Application Data
(60) Provisional application No. 62/278,340, filed on Jan. 13, 2016.

(51) Int. Cl. H04L 29/06; H04L 29/08

(52) U.S. Cl. CPC H04L 65/403; H04L 67/42; H04L 67/10; H04L 67/02

(57) ABSTRACT

According to innovative aspects, the subject matter described in this disclosure may be embodied in a server having a memory and one or more processors configured to execute instructions stored on the memory, wherein the server is configured to perform operations comprising: transmitting, by a cloud operating system running on the server, a first graphical user interface for display on a client device; receiving authentication information, via the first graphical user interface, at the cloud operating system; receiving a selection of a service, by the cloud operating system, from the client device via the first graphical user interface; and transmitting, by a service operating system running on the server, a second graphical user interface for display on the client device.

### CROSS REFERENCE TO RELATED APPLICATIONS

The present application claims priority, under 35 U.S.C. § 119, of U.S. Provisional Patent Application No. 62/278,340, filed Jan. 13, 2016 and entitled “Collaborative Platform for Communication, Application Development and Use,” which is incorporated by reference in its entirety.

### BACKGROUND

The present disclosure relates to a collaborative platform for communication, application development, and use. Currently, collaborative platforms exist that allow users to communicate and collaborate on textual and graphic documents. These solutions use special software to coordinate the contributions of the users in the session. For example, during such a collaborative session, the original text document may be saved to a central server, while each user contributes changes that are identifiable as such. When the users agree to the collaborative edits and enhancements, the entire text file is refreshed and saved. Similarly, a design or a concept can be developed graphically and on a collaborative basis through whiteboarding, much as the users would do on a physical whiteboard in a face-to-face meeting. Each user can modify the initial drawing, with each individual's contribution identified by separate color. Again, once the group has agreed on the final graphic rendition, the graphic is saved. However, existing collaborative platforms have security and other limitations that are addressed by the techniques disclosed herein.

### SUMMARY

The present disclosure relates to a collaborative platform for communication, application development, and use.

According to innovative aspects, the subject matter described in this disclosure may be embodied in a server having a memory and one or more processors configured to execute instructions stored on the memory, wherein the server is configured to perform operations comprising: transmitting, by a cloud operating system running on the server, a first graphical user interface for display on a client device; receiving authentication information, via the first graphical user interface, at the cloud operating system; receiving a selection of a service, by the cloud operating system, from the client device via the first graphical user interface; and transmitting, by a service operating system running on the server, a second graphical user interface for display on the client device.

In further embodiments, the cloud operating system and the service operating system are running on a virtual private server on the server. In yet further embodiments, the cloud operating system and the service operating system are running in a container on the virtual private server on the server. In yet further embodiments, the first graphical user interface and the second graphical user interface are configured to be operated as a web application in a web browser. In yet further embodiments, the operations comprise transmitting, by the cloud operating system, the first graphical user interface to a streaming client via a streaming server. In yet further embodiments, the operations comprise transmitting, by the cloud operating system, the first graphical user interface using a first protocol and transmitting, by the service operating system, the second graphical user interface using a second protocol. In yet further embodiments, the service comprises one of a mail service, a chat service, a timeline service, an application streaming service, and a collaboration service.

According to innovative aspects, the subject matter described in this disclosure may be embodied in a computer implemented method including: transmitting, by a cloud operating system running on a server, a first graphical user interface for display on a client device; receiving authentication information, via the first graphical user interface, at the cloud operating system; receiving a selection of a service, by the cloud operating system, from the client device via the first graphical user interface; and transmitting, by a service operating system running on the server, a second graphical user interface for display on the client device.

In further embodiments, the cloud operating system and the service operating system are running on a virtual private server on the server. In further embodiments, the cloud operating system and the service operating system are running in a container on the virtual private server on the server. In yet further embodiments, the client device displays the first graphical user interface and the second graphical user interface as a web application in a web browser. In yet further embodiments, the method further includes transmitting, by the cloud operating system, the first graphical user interface to a streaming client via a streaming server. In yet further embodiments, the method further includes transmitting, by the cloud operating system, the first graphical user interface using a first protocol and the service operating system transmits the second graphical user interface using a second protocol. In yet further embodiments, the service comprises one of a mail service, a chat service, a timeline service, an application streaming service, and a collaboration service.

Other implementations of one or more of these aspects include corresponding systems, apparatus, and computer programs, configured to perform the actions of the methods, encoded on computer storage devices. It should be understood that the language used in the present disclosure has been principally selected for readability and instructional purposes, and not to limit the scope of the subject matter disclosed herein.

### BRIEF DESCRIPTION OF THE DRAWINGS

The techniques of the present disclosure are illustrated by way of example, and not by way of limitation in the figures of the accompanying drawings in which like reference numerals are used to refer to similar elements.

FIG. 1 is a high-level block diagram illustrating an example system for a collaborative platform, according to the techniques introduced herein.

FIG. 2 is a block diagram illustrating an example server of the collaborative platform in FIG. 1, according to the techniques introduced herein.

FIG. 3 is a block diagram illustrating an example client device of the collaborative platform in FIG. 1, according to the techniques introduced herein.

FIG. 4 is a block diagram illustrating another example client device of the collaborative platform in FIG. 1, according to the techniques introduced herein.

FIG. 5 is a block diagram illustrating an example system for a collaborative platform providing an application streaming protocol, according to the techniques introduced herein.

FIG. 6 is a flow diagram depicting an example communication between a streaming server and a streaming client, according to the techniques introduced herein.

FIG. 7 is a block diagram illustrating an example system depicting secure document sharing between client devices in a collaborative platform, according to the techniques introduced herein.

FIG. 8 is a flow diagram depicting an example flow of secure document sharing between client devices in a collaborative platform, according to the techniques introduced herein.

FIG. 9 is an example screenshot depicting an interface for sharing a document with another user via a peer-to-peer connection as described in the examples of FIGS. 7 and 8, according to the techniques described herein.

FIG. 10 is an example screenshot depicting an interface for a mail application implemented by a mail operating system, according to the techniques described herein.

FIG. 11 is an example screenshot depicting an interface for a timeline application implemented by a timeline operating system, according to techniques described herein.

FIG. 12 is an example screenshot depicting an interface for a cloud storage application implemented by a cloud operating system, according to techniques described herein.

FIG. 13 is an example screenshot depicting an application interface implemented by an application operating system, according to techniques described herein.

FIG. 14 is an example screenshot depicting an interface for a chat application implemented by a chat operating system, according to techniques described herein.

FIG. 15 is an example screenshot depicting an interface for making voice calls implemented by a chat operating system, according to techniques described herein.

### DETAILED DESCRIPTION

Systems and methods for a collaborative platform for communication, application development, and use are described below. While the systems and methods of the present disclosure are described in the context of a particular system architecture, it should be understood that the systems and methods can be applied to other architectures and organizations of hardware.

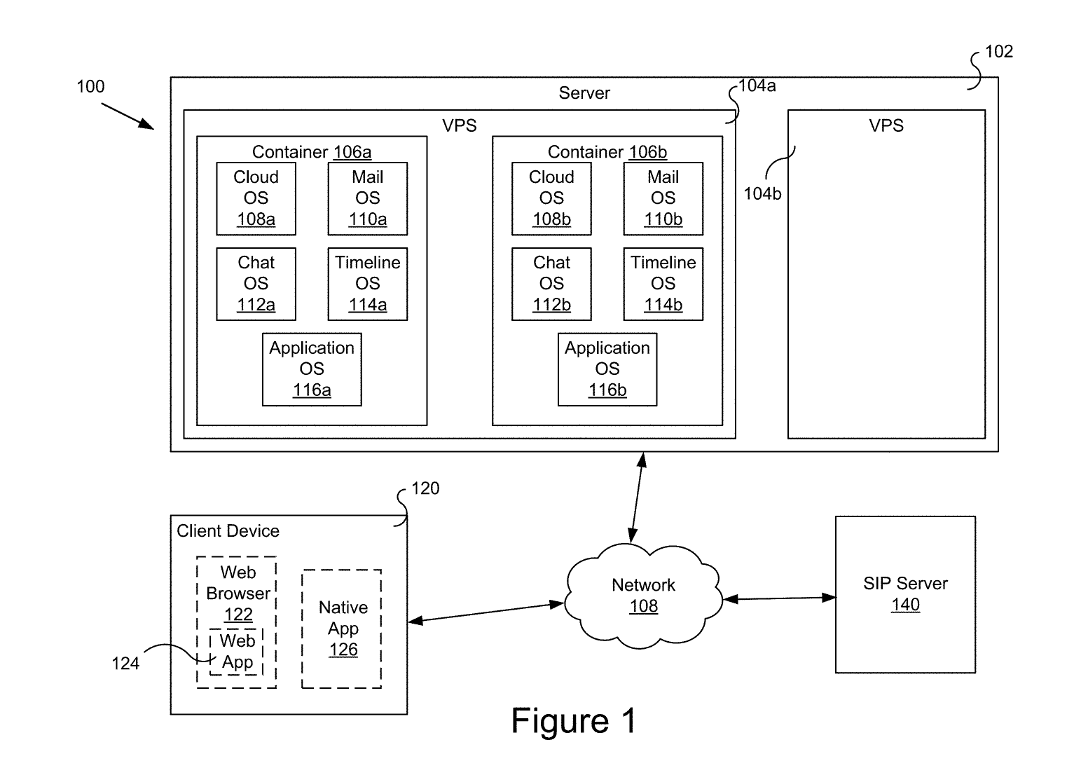

FIG. 1 is a high-level block diagram illustrating an example system 100 for a collaborative platform. In some embodiments, the collaborative platform is a collection of software applications running on a server 102 and a client device 120. The server 102 may be, for example, a computer program or device that provides functionality for other programs or devices, such as client device 120. In various embodiments, the server 102 may be a discrete server, a server farm or cluster, or any other configuration of computing devices configured to provide the services described herein. In some embodiments, the client device 120 may be, for example, a laptop computer, a desktop computer, a tablet computer, a mobile telephone, a personal digital assistant, a mobile email device, a portable game player, a portable music player, a television with one or more processors embedded therein or coupled thereto or any other electronic device capable of making requests to the server 102 and receiving responses from the server 102.

In some embodiments, the server 102 is configured to run a virtual private server (VPS) 104. As depicted in the example of FIG. 1, two virtual private servers (e.g., virtual private servers 104a and 104b) are depicted, although the server 102 may run any number of virtual private servers 104 to adapt the capacity of the system 102 to the number of users and the workload from those users.

In some embodiments, further virtualization of the server 102 may be accomplished using containers 106 running on one or more virtual private servers 104 on server 102. In one embodiment, the containers 106 may be a complete filesystem that contains everything needed (e.g., code, runtime, system tools, system libraries) to run applications launched within the containers 106. The containers 106 isolate applications from one another and the underlying infrastructure, while providing an added layer of protection for the application. In some embodiments, the containers 106 include applications and all of their dependencies—but share the underlying host operating system kernel with other containers 106, running as isolated processes in user space on the host operating system. As described herein, containers 106 are not tied to any specific infrastructure, i.e., they run on any computer or on any infrastructure. Packaging an application in a container with all of its dependencies provides scalability to the system 100 when additional users or resources are needed, a replication of the container may be made that will work as designed without having to worry about configuring the new applications based on the environment. In other embodiments, the containers 106 may include the applications, the necessary binaries and libraries, and an entire guest operating system.

Each container 106 may include one or more applications. For example, as depicted in FIG. 1, container 106a includes a cloud operating system 108a, a mail operating system 110a, a chat operating system 112a, a timeline operating system 114a, and an application operating system 116a. As depicted in the example of FIG. 1, each application running in a container 106 is a lightweight, special purpose operating system. In one embodiment, the lightweight, special purpose operating systems comprise a Linux based kernel with additional elements to perform the specific functions of the operating system.

Cloud operating system 108 is configured to provide a gateway to the remaining operating systems and/or applications provided by the system 100. For example, cloud operating system 108 may provide a website subsystem and a dashboard for the collaborative platform 100. The website subsystem provides an interface for a user to register and/or login to an account, add or modify domains and subdomains, update configuration settings, and access billing information. Further, in some embodiments, the dashboard provides an interface for an administrator to manage domains and user accounts within a domain, view usage statistics, and monitor/scale services. Cloud operating system 108 provides an interface for a user to select programs or services available to the user. For example, the cloud operating system 108 provides a user interface with icons corresponding to services that are selectable by a user, as described in more detail herein. The cloud operating system interface further provides access to a cloud storage system (as described elsewhere herein).

Mail operating system 110 is configured to provide an email application to users of the system 100. In some embodiments, the email application provides a collaborative email system. In the collaborative email system, users can share inboxes, folders, mail messages, etc. with other users. The addition of a shared inbox, folder, etc. allows a shared user to respond or manage mail messages, even if the shared user was not copied or sent the original message. Additionally, the email application supports mail protocols for use with external mail clients.

In some embodiments, other services provided by the system 100 are accessible via the mail operating system 110. For example, a chat application provided by the chat operating system 112 may be accessible via a user interface generated by the mail operating system. In another embodiment, the mail operating system 110 is integrated with the cloud storage system, which allows users to directly access and attach documents to emails or save documents attached to emails and continually have access to those attachments from any client device the user accesses the system 100. In further embodiments, the mail operating system 110 is integrated with the timeline operation system 114 to provide email notifications in an event stream provided by the timeline operating system 114. Further, in some embodiments, mail operating system 110 provides access to third party applications and/or services to read and/or compose messages and operate the mail system on behalf of the user. The mail operating system 110 provides full control to users over the level of access offered to third party applications, for example, by providing a settings menu.

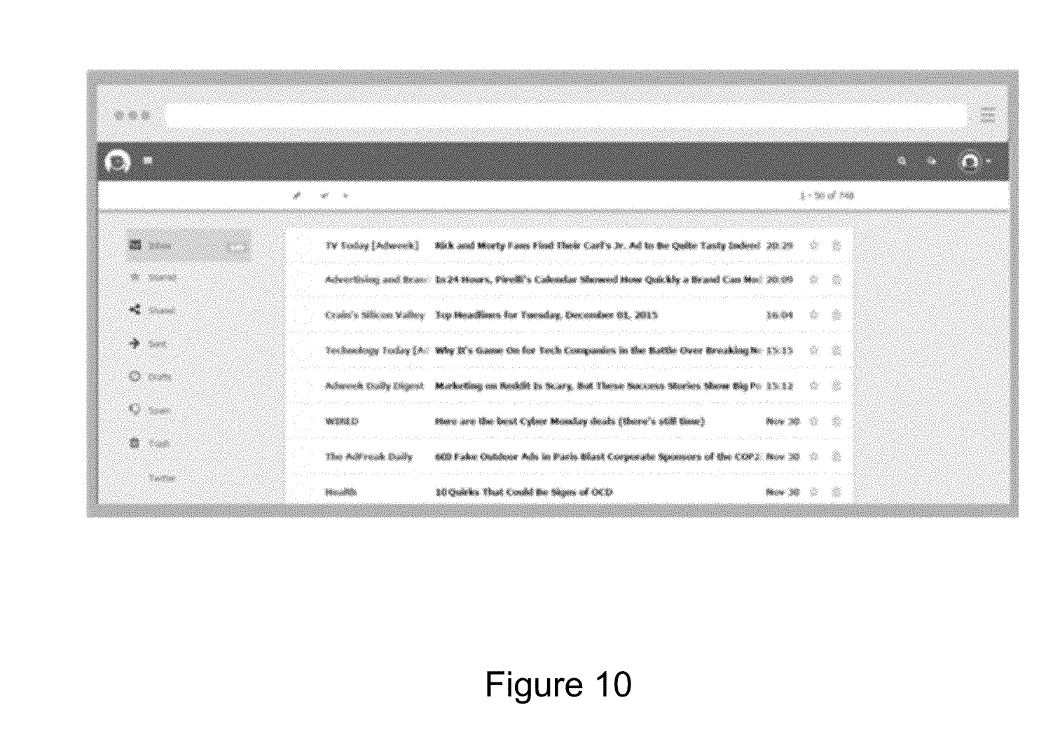

FIG. 10 is an example screenshot depicting an interface for a mail application implemented by mail operating system 110.

Chat operating system 112 is configured to provide a collaborative messaging system. In one embodiment, the collaborative messaging system operates using an extensible messaging and presence protocol (XMPP). In some embodiments, the collaborative messaging system includes a channel feature that allows conversations to be organized in open channels. For example, channels corresponding to a project, a topic, a team, etc. can be created to organize and give users access to conversations that are relevant. In some embodiments, the collaborative messaging system includes a private channel feature that allows sensitive content to be seen by only those users who have been invited to view and contribute to the private channel. In further embodiments, the collaborative messaging system includes a direct messaging feature that allows users to message another user directly without the message being included in an open or a private channel

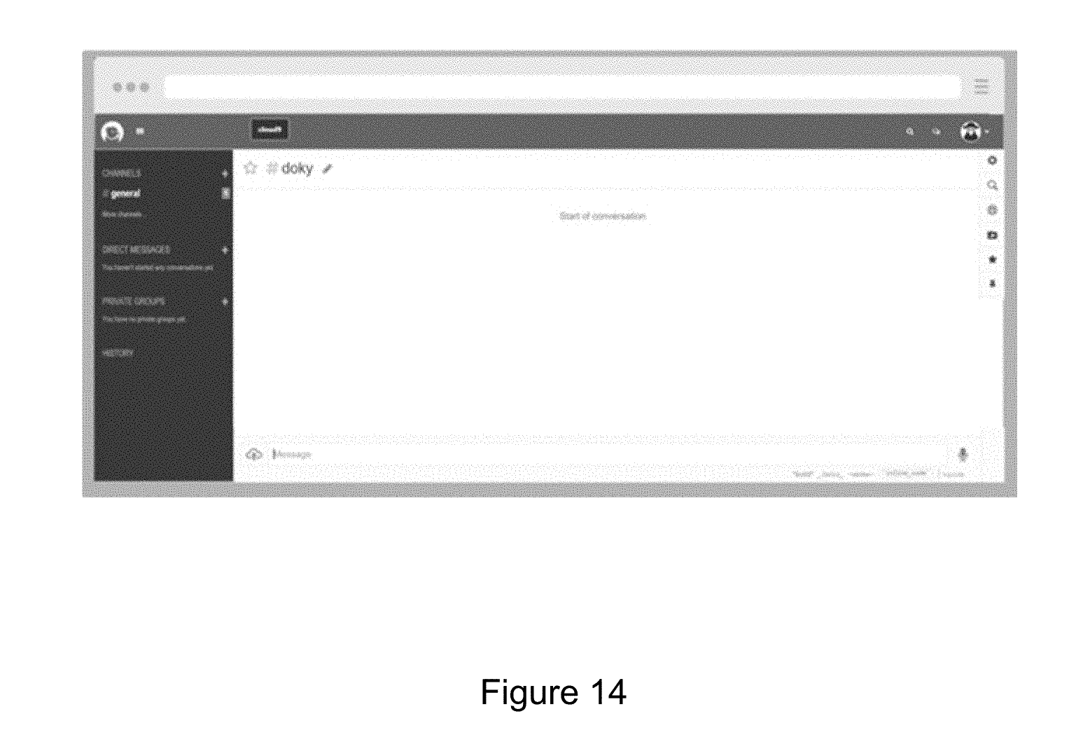

In some embodiments, the collaborative messaging feature is integrated with the cloud storage system allowing drag and drop sharing of files (e.g., documents, images, spreadsheets, PDFs, etc.) with users who have access to a channel or a private message. Further, the files are maintained on the cloud storage system such that users can access the files later by reviewing the channel or chart history or by searching for the document name and/or type. In some embodiments, the collaborative messaging feature is integrated with third party applications to send or access messages on behalf of the user. For example, access can be provided to a vendor to allow the vendor to send a message or post to channel when a product becomes available or a shipment has been made. Additionally, since the XMPP protocol is supported by other chat and messaging systems, the base functionality of the collaborative messaging system can be used to post and/or receive messages from these other systems. FIG. 14 is an example screenshot depicting an interface for a chat application implemented by chat operating system 112.

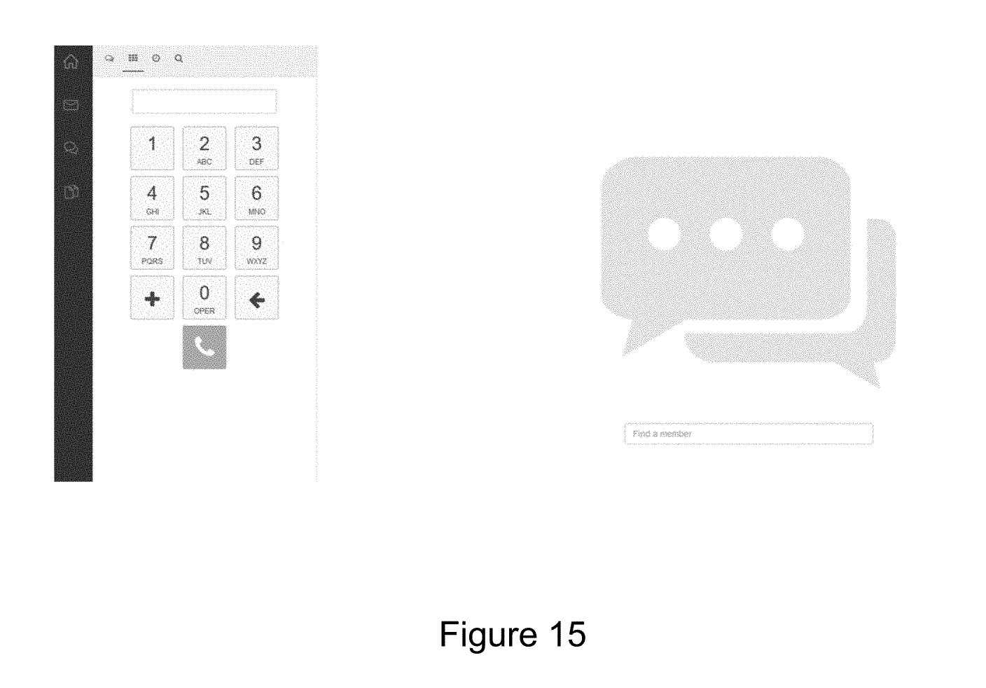

In some embodiments, the chat operating system 112 is integrated with session initiation protocol (SIP) server 140 to provide voice and video call functionality within the collaborative messaging system. For example, the collaborative messaging system includes a voice call interface configured to receive a telephone number from a user to initiate a voice call to the number. The chat operating system 112 is therefore able to provide some voice call coverage without the need for a dedicated telephone service. FIG. 15 is an example screenshot depicting an interface for making voice calls implemented by chat operating system 112.

The timeline operating system 114 is configured to provide an event stream that can be personalized and curated by each user to provide a global view overview of items of interest to the user. The event stream, in various embodiments, may be filtered according to time, source, user, group, etc. Additionally, users can subscribe to other users, like, comment, and share posts found on the event stream. In some embodiments, the event stream may include support for posting/viewing images, audio, video, and other attachments. Further, access to posts in the event stream can be granted based on various criteria, for example, based on a user, team, organization, public, etc. In some embodiments, the event stream is integrated with other services provided by the system 100. For example, the timeline operating system 114 is integrated with the mail operating system 110 such that users can share emails in the event stream of other users. In some embodiments, the integration between the mail operating system 110 and the timeline operating system 114 allows users to respond to emails posted to the event stream (e.g., even if the original message was not sent to a mailbox of the user). In other embodiments, the timeline operating system is integrated with the cloud storage system to provide file sharing access via the event stream. When a document is posted to the event stream, other users can view and/or update the document via the cloud storage system. In further embodiments, the timeline operating system 114 is integrated with the chat operating system 116 to provide direct messaging capability to users directly from the event stream (e.g., to respond to or share a post with another user directly). In one embodiment, the timeline operating system 114 is integrated with the application operating system 116. The integration between the timeline operating system 114 is integrated with the application operating system 116 allows users to view and edit documents within the event stream. In some embodiments, the timeline operating system is integrated with third party applications, for example via OAUTH or other known protocols, to allow third-party applications to push posts to the event stream.

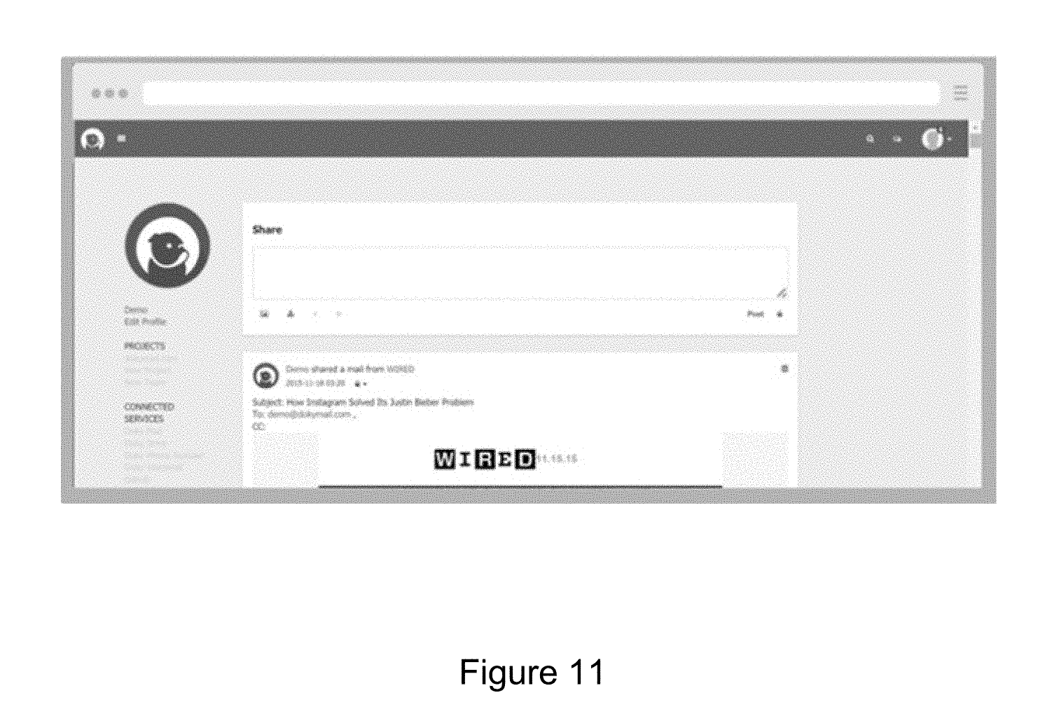

FIG. 11 is an example screenshot depicting an interface for a timeline application implemented by timeline operating system 112.

The application operating system 116 provides a virtual environment manager that provides access to desktop applications running on the application operating system 116. In one embodiment, each application running on the application operating system 116 operates within its own sandboxed environment that exists independent of the underlying hardware and is unaware of other applications running on the application operating system 116. In some embodiments, each application is allocated resources that are reserved for the user running the application. The resources allocated to the user can be distributed or moved among physical servers (e.g., in a server cloud). Thus, the application can be started, paused, moved, restarted, etc. without effecting the state of the application. Additionally, multiple instances of the application can be run by the application operating system 116, each in its own virtual environment. Any changes made by to an application or to the application's environment remains within the virtual environment associated with that instance of the environment. Thus, an application is not susceptible to corruption (e.g., via malware or virus) and each new instance of the application starts with a fresh, genuine copy of the environment.

In some embodiments, applications run by the application operating system 116 may include applications from various categories, for example, an office suite, utilities (such as a compression application, PDF viewer, etc.), applications for developers, etc. The application operating system 116 generates a user interface that is transmitted to the client device 120 for presentation and to receive input from a user. In some embodiments, the application operating system 116 provides the user interface to multiple client devices where one or more users can interact with or view the application. In one embodiment, the application operating system 116 is integrated with the mail operating system 110 to allow users to view and edit documents within a mail message. In some embodiments, the application operating system 116 is integrated with the cloud storage system to allow users to view and edit documents that are stored in the cloud storage system.

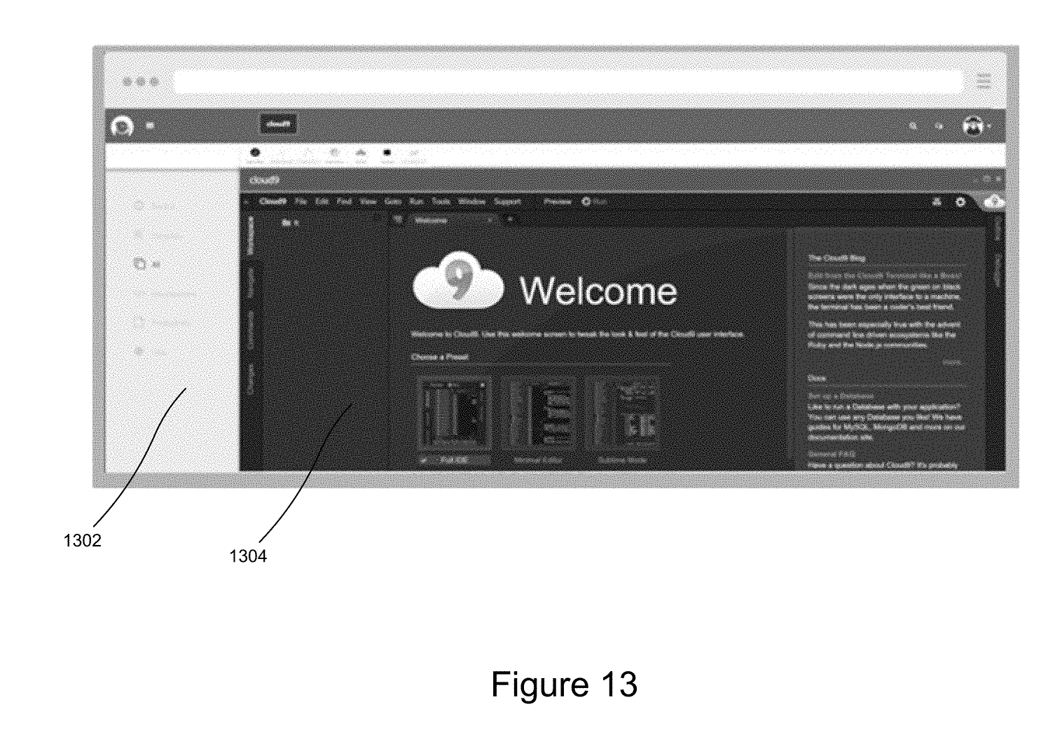

FIG. 13 is an example screenshot depicting an application interface implemented by an application operating system 116. As depicted in the example of FIG. 13, the application interface is displayed in a window 1304 within the browser or native application window 1302.

In some embodiments, a software development kit is available for creation of applications to run on application operating system 116. In various embodiments, the software development kit includes application programming interfaces, programming tools, and documentation for software developers to program applications for use on the collaborative platform. The software development kit may be used to encourage developers to use and develop applications for the collaborative platform.

The server 102, the client device 120, and SIP server 140 are interconnected in a data communication network 118. The data communication network 118 can be a conventional type, wired or wireless, and may have numerous different configurations including a star configuration, token ring configuration, or other configurations. Furthermore, the data communication network 118 may include a local area network (LAN), a wide area network (WAN) (e.g., the internet), and/or other interconnected data paths across which multiple devices (e.g., a computing device comprising the server 102 and the client device 120, etc.) may communicate. In some embodiments, the data communication network 118 may be a peer-to-peer network. The data communication network 118 may also be coupled with or include portions of a telecommunications network for sending data using a variety of different communication protocols. In some embodiments, the data communication network 118 may include Bluetooth (or Bluetooth low energy) communication networks or a cellular communications network for sending and receiving data, including via short messaging service (SMS), multimedia messaging service (MMS), hypertext transfer protocol (HTTP), direct data connection, wireless application protocol (WAP), email, etc.

The arrangement of elements on server 102, as depicted in the example of FIG. 1, allows for massive scalability of users that can be connected to and take advantage of the services provided by the operating systems of the collaborative platform. For example, multiple users accessing multiple operating systems and applications can be accommodated within a single container (e.g., container 106a). In some embodiments, the number of containers 106 and virtual private servers 104 depends on the number of users and applications accessed by those users. As the number of users fluctuates, the number of containers 106 and virtual private servers 104 running on the server 102 are adjusted to provide adequate resources for the users.

The client device 120 may be a computing device configured to run an application for a user to access the components of the collaborative platform 100. For example, in one embodiment, a user may launch a web browser 122 on client device 120 and enter an address for the cloud operating system 108. In some embodiments, the web browser provides access to web application 124 that is provided by cloud operating system 108 to access services provided by the system 100. In another embodiment, the user launches a native application 126 on the client device 120 to access services provided by the system 100.

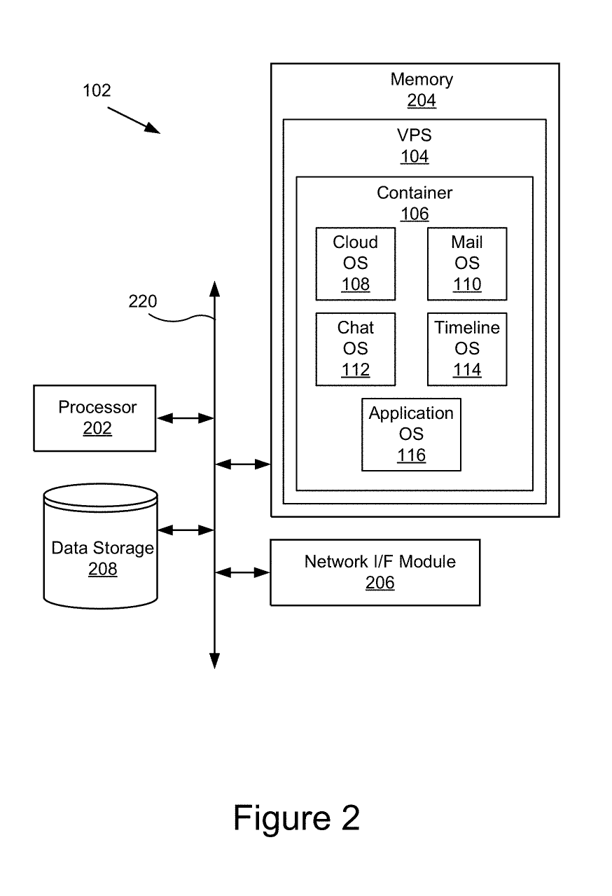

FIG. 2 is a block diagram illustrating an example server 102 of the collaborative platform 100 in FIG. 1. In the example of FIG. 2, the server 102 includes a processor 202, a memory 204, a network interface (I/F) module 206, and data storage 208. The components of the server 102 are communicatively coupled to a bus or software communication mechanism 220 for communication with each other.

The processor 202 may include an arithmetic logic unit, a microprocessor, a general-purpose controller or some other processor array to perform computations. In some embodiments, the processor 202 is a hardware processor having one or more processing cores. The processor 202 is coupled to the bus or software communication mechanism 220 for communication with the other components of the server 102. Processor 202 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 2, multiple processors and/or processing cores may be included. It should be understood that other processor configurations are possible. As described elsewhere herein, the server 102 may be distributed among multiple hardware servers each having a configuration similar to that depicted in the example of FIG. 2.

The memory 204 stores instructions and/or data that may be executed by the processor 202. In the illustrated embodiment, the memory 204 includes a virtual private server 104, a container 106, a cloud operating system 108, a mail operating system 110, a chat operating system 112, a timeline operating system 114, and an application operating system 116. The memory 204 is coupled to the bus or software communication mechanism 220 for communication with the other components of the server 102. The instructions and/or data stored in the memory 204 may include code for performing the techniques described herein. The memory 204 may be, for example, non-transitory memory such as a dynamic random access memory (DRAM) device, a static random access memory (SRAM) device, flash memory, or some other memory device. In some embodiments, the memory 204 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

The network interface module 206 is configured to connect the server 102 to a data communication network (e.g., network 118). For example, the network interface module 206 may enable communication through one or more of the internet, cable networks, and wired networks. The network interface module 206 links the processor 202 to the data communication network that may in turn be coupled to other processing systems. The network interface module 206 also provides other conventional connections to the data communication network for distribution and/or retrieval of data objects (e.g., files and/or media objects) using standard network protocols such as Transmission Control Protocol/Internet Protocol (TCP/IP), Hypertext Transfer Protocol (HTTP), Secure Hypertext Transfer Protocol (HTTPS), and Simple Mail Transfer Protocol (SMTP) as will be understood. In some embodiments, the network interface module 206 includes a transceiver for sending and receiving signals using WiFi, Bluetooth®, or cellular communications for wireless communication.

Further, as depicted in the example of FIG. 2, the server 102 includes data storage 208. In the illustrated embodiment, the data storage 208 is communicatively coupled to the bus or software communication mechanism 220. In one embodiment, the data storage 208 is a non-transitory memory that stores data for providing the functionality described herein. The data storage 208 may be a dynamic random access memory (DRAM) device, a static random access memory (SRAM) device, flash memory or some other memory devices. In some embodiments, the data storage 208 may also include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. In some embodiments, data storage 208 comprises a scalable, fault tolerant, regionally distributed filesystem including multiple storage devices as those described herein to provide large amounts of storage for operation of the collaborative platform 100.

In one embodiment, the cloud operating system 108 is configured to implement a cloud storage system using the data storage 208. In some embodiments, the cloud storage system operates as a file storage and synchronization service. For example, the cloud storage system allows users to store files on the collaborative platform 100. Additionally, the cloud storage system allows the files to be shared with other users for editing and viewing using applications running on application operating system 116 as described herein. The cloud operating system 108 provides an interface for a user to maintain and access files stored to the cloud storage system. In one embodiment, the interface allows a user to create, add, or upload files using a single button. In one embodiment, the interface includes a search function to allow users to find saved and shared files more easily. In some embodiments, the interface appears in a folder structure including drag-and-drop functionality similar to that provided by a desktop operating system. In other embodiments, the interface includes features for sharing files and/or folders with other users.

In some embodiments, the cloud storage system may be accessed by users using a native application 126 on a client device 120 such as a mobile phone or tablet computer. In such embodiments, the cloud operating system 108 provides additional functionality for accessing the cloud storage system. For example, a user may scan documents using a camera on the client device 120 and save the file to the cloud storage system.

In some embodiments, native application 126 provides local storage synchronization on client device 120 with the cloud storage system. In such embodiments, files stored on the cloud storage system may be accessed on the client device 120 even when network 118 is unavailable to connect to the server 102. Further, changes made to files, or the addition of new files in the local storage of client device, may be synchronized with the cloud storage system when a connection to network 118 is reestablished. As described elsewhere herein, other services provided by the operating systems of the collaborative system are integrated with the cloud storage system.

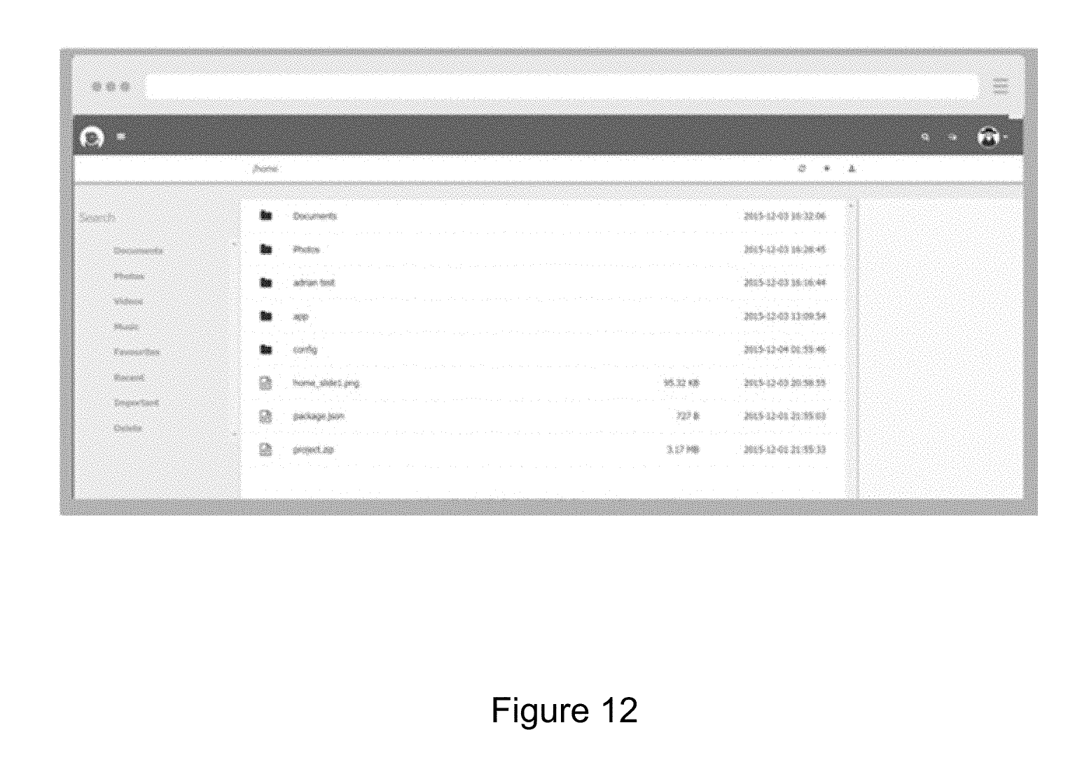

FIG. 12 is an example screenshot depicting an interface for a cloud storage application implemented by a cloud operating system 108.

Bus or software communication mechanism 220 may be an object bus (e.g., Common Object Request Broker Architecture (CORBA)), direct socket communication (e.g., TCP/IP sockets) among software modules, remote procedure calls, User Datagram Protocol (UDP) broadcasts and receipts, HTTP connections, function or procedure calls, etc. Further, any or all of the communication could be secure (e.g., Secure Shell (SSH), HTTPS, etc.). The bus or software communication mechanism 220 can be implemented on any underlying hardware, for example, a network, the Internet, a bus, a combination thereof, etc.

In the illustrated embodiment of FIG. 2, the memory 204 includes a virtual private server 104, a container 106, a cloud operating system 108, a mail operating system 110, a chat operating system 112, a timeline operating system 114, and an application operating system 116. The various operating systems are stored on memory 204 and configured to be executed by the processor 202, to perform the operations described herein.

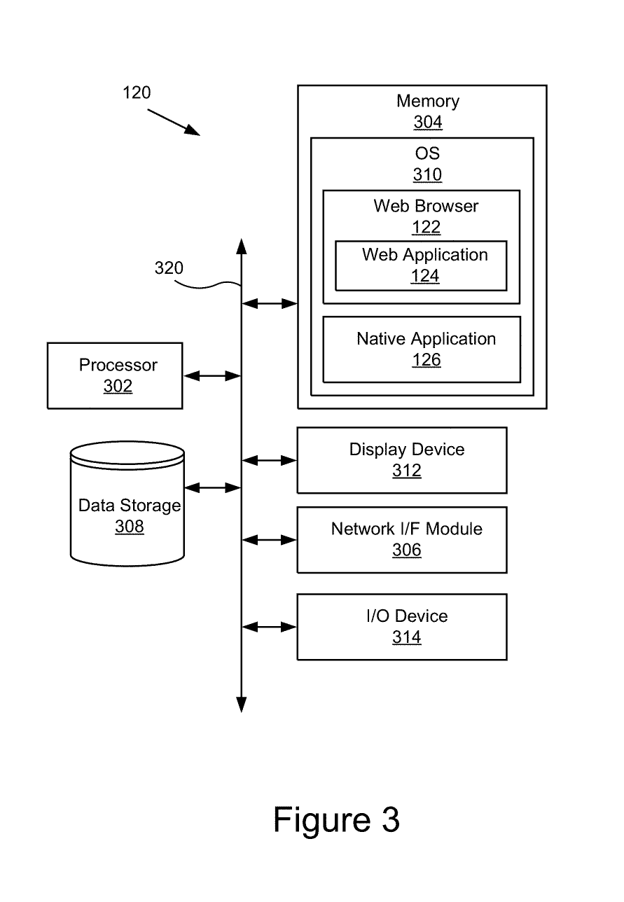

FIG. 3 is a block diagram illustrating an example client device 120 of the collaborative platform 100 in FIG. 1. In the example of FIG. 3, the server 120 includes a processor 302, a memory 304, a network interface (I/F) module 306, and data storage 308. The components of the client device 120 are communicatively coupled to a bus or software communication mechanism 320 for communication with each other.

The processor 302 may include an arithmetic logic unit, a microprocessor, a general-purpose controller or some other processor array to perform computations and provide electronic display signals to a display device, such as display device 312. In some embodiments, the processor 302 is a hardware processor having one or more processing cores. The processor 302 is coupled to the bus or software communication mechanism 320 for communication with the other components of the client device 120. Processor 302 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 3, multiple processors and/or processing cores may be included. It should be understood that other processor configurations are possible.

The memory 304 stores instructions and/or data that may be executed by the processor 302. In the illustrated embodiment, the memory 304 includes an operating system 310 a web browser 122, a web application 124, and a native application 126. The memory 304 is coupled to the bus or software communication mechanism 320 for communication with the other components of the client device 120. The instructions and/or data stored in the memory 304 may include code for performing the techniques described herein. The memory 304 may be, for example, non-transitory memory such as a dynamic random access memory (DRAM) device, a static random access memory (SRAM) device, flash memory, or some other memory device. In some embodiments, the memory 304 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

The network interface module 306 is configured to connect the client device 120 to a data communication network (e.g., network 118). For example, the network interface module 308 may enable communication through one or more of the internet, cable networks, and wired networks. The network interface module 306 links the processor 302 to the data communication network that may in turn be coupled to other processing systems. The network interface module 306 also provides other conventional connections to the data communication network for distribution and/or retrieval of data objects (e.g., files and/or media objects) using standard network protocols such as Transmission Control Protocol/Internet Protocol (TCP/IP), Hypertext Transfer Protocol (HTTP), Secure Hypertext Transfer Protocol (HTTPS), and Simple Mail Transfer Protocol (SMTP) as will be understood. In some embodiments, the network interface module 306 includes a transceiver for sending and receiving signals using WiFi, Bluetooth®, or cellular communications for wireless communication.

Further, as depicted in the example of FIG. 3, the client device 120 includes data storage 308. In the illustrated embodiment, the data storage 308 is communicatively coupled to the bus or software communication mechanism 320. In one embodiment, the data storage 308 is a non-transitory memory that stores data for providing the functionality described herein. The data storage 308 may be a dynamic random access memory (DRAM) device, a static random access memory (SRAM) device, flash memory or some other memory devices. In some embodiments, the data storage 308 may also include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The display device 312 is a liquid crystal display (LCD), light emitting diode (LED) or any other similarly equipped display device, screen or monitor. The display device 312 represents any device equipped to display user interfaces, electronic images and data as described herein. In different embodiments, the display is binary (only two different values for pixels), monochrome (multiple shades of one color), or allows multiple colors and shades. The display device 312 is coupled to the bus or software communication mechanism 320 for communication with the processor 402 and the other components of the client device 120.

Bus or software communication mechanism 320 may be an object bus (e.g., Common Object Request Broker Architecture (CORBA)), direct socket communication (e.g., TCP/IP sockets) among software modules, remote procedure calls, User Datagram Protocol (UDP) broadcasts and receipts, HTTP connections, function or procedure calls, etc. Further, any or all of the communication could be secure (e.g., Secure Shell (SSH), HTTPS, etc.). The bus or software communication mechanism 320 can be implemented on any underlying hardware, for example, a network, the Internet, a bus, a combination thereof, etc.

In the illustrated embodiment of FIG. 3, the memory 304 includes an operating system 310, a web browser 122, a web application 124 and a native application 126. The operating system 310, the web browser 122, the web application 124 and the native application 126 are stored on memory 304 and configured to be executed by the processor 302, to perform the operations described herein. For example, the web browser 122 may be a browser such as Google Chrome, Mozilla Firefox, Microsoft Edge, or the like. In some embodiments, the web browser 122 is configured to render HTMLS or other web markup language to display the interfaces generated by the operating systems running on server 102. In some embodiments, the web markup language includes instructions to render a web application 124 within the web browser 122. The web application 124 displays the interfaces provided by the operating systems running on server 102 and allows a user to interact with the interfaces via input/output (I/O) device 314. In some embodiments, the web application 124 uses a client/server model, as described elsewhere herein, for providing the interface for display to the user.

The native application 126 comprises code to render an interface provided by the operating systems running on server 102 and allows a user to interact with the interfaces via input/output (I/O) device 314. In some embodiments, the native application 126 uses a client/server model, as described elsewhere herein, for providing the interface for display to the user and interactions from the user to the server 102.

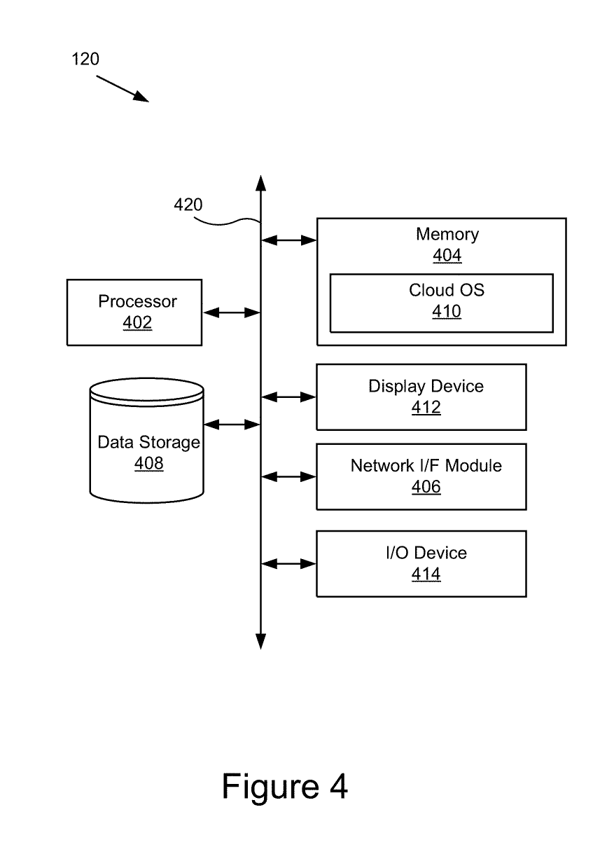

FIG. 4 is a block diagram illustrating another example client device 120 of the collaborative platform 100 in FIG. 1. In the example of FIG. 4, the server 120 includes a processor 402, a memory 404, a network interface (I/F) module 406, and data storage 408. The components of the client device 120 are communicatively coupled to a bus or software communication mechanism 420 for communication with each other.

The processor 402 may include an arithmetic logic unit, a microprocessor, a general-purpose controller or some other processor array to perform computations and provide electronic display signals to a display device, such as display device 412. In some embodiments, the processor 402 is a hardware processor having one or more processing cores. The processor 402 is coupled to the bus or software communication mechanism 420 for communication with the other components of the client device 120. Processor 402 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 4, multiple processors and/or processing cores may be included. It should be understood that other processor configurations are possible.

The memory 404 stores instructions and/or data that may be executed by the processor 402. In the illustrated embodiment, the memory 404 includes a cloud operating system 410. The memory 404 is coupled to the bus or software communication mechanism 420 for communication with the other components of the client device 120. The instructions and/or data stored in the memory 404 may include code for performing the techniques described herein. The memory 404 may be, for example, non-transitory memory such as a dynamic random access memory (DRAM) device, a static random access memory (SRAM) device, flash memory, or some other memory device. In some embodiments, the memory 404 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

The network interface module 406 is configured to connect the client device 120 to a data communication network (e.g., network 118). For example, the network interface module 408 may enable communication through one or more of the internet, cable networks, and wired networks. The network interface module 406 links the processor 402 to the data communication network that may in turn be coupled to other processing systems. The network interface module 406 also provides other conventional connections to the data communication network for distribution and/or retrieval of data objects (e.g., files and/or media objects) using standard network protocols such as Transmission Control Protocol/Internet Protocol (TCP/IP), Hypertext Transfer Protocol (HTTP), Secure Hypertext Transfer Protocol (HTTPS), and Simple Mail Transfer Protocol (SMTP) as will be understood. In some embodiments, the network interface module 406 includes a transceiver for sending and receiving signals using WiFi, Bluetooth®, or cellular communications for wireless communication.

Further, as depicted in the example of FIG. 4, the client device 120 includes data storage 408. In the illustrated embodiment, the data storage 408 is communicatively coupled to the bus or software communication mechanism 420. In one embodiment, the data storage 408 is a non-transitory memory that stores data for providing the functionality described herein. The data storage 408 may be a dynamic random access memory (DRAM) device, a static random access memory (SRAM) device, flash memory or some other memory devices. In some embodiments, the data storage 408 may also include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The display device 412 is a liquid crystal display (LCD), light emitting diode (LED) or any other similarly equipped display device, screen or monitor. The display device 412 represents any device equipped to display user interfaces, electronic images and data as described herein. In different embodiments, the display is binary (only two different values for pixels), monochrome (multiple shades of one color), or allows multiple colors and shades. The display device 412 is coupled to the bus or software communication mechanism 420 for communication with the processor 402 and the other components of the client device 120.

Bus or software communication mechanism 420 may be an object bus (e.g., Common Object Request Broker Architecture (CORBA)), direct socket communication (e.g., TCP/IP sockets) among software modules, remote procedure calls, User Datagram Protocol (UDP) broadcasts and receipts, HTTP connections, function or procedure calls, etc. Further, any or all of the communication could be secure (e.g., Secure Shell (SSH), HTTPS, etc.). The bus or software communication mechanism 420 can be implemented on any underlying hardware, for example, a network, the Internet, a bus, a combination thereof, etc.

In the illustrated embodiment of FIG. 4, the memory 404 includes a cloud operating system 410. The cloud operating system 410 is stored on memory 404 and configured to be executed by the processor 402, to perform the operations described herein. In one embodiment, the cloud operating system 410 is configured to connect to a server (e.g., server 102) in response to a request from a user to access an application or service provided by the collaborative platform. In some embodiments, as services and applications are requested, the respective application and service are downloaded to client device 120 and are accessible in an offline mode. Any changes to files that are made while services are being accessed in an offline mode are synchronized with server 102 when the client device 120 is again connected to network 108.

In some embodiments, cloud operating system 410 is a complete bootable computer installation including operating system which runs in a computer's memory, rather than loading from a hard disk drive. Launching cloud operating system 410 in this manner allows users to run the operating system 410 without installing the operating system 410 on data storage 408 or making any changes to the configuration of client device 102. Cloud operating system 410 can run on a client device 120 without secondary storage, such as a hard disk drive, or with a corrupted hard disk drive or file system, allowing data recovery. In some embodiments, cloud operating system 410 may be an ISO image of cloud operating system 410 which can be used in virtual machine environments, mounted as if it were a CD/DVD and used as the virtual machine's boot CD.

The functionality of cloud operating system 410 is also available with a bootable live USB flash drive, or even an external USB drive or Boot from BIOS and Network. These may have the added functionality of writing changes on the bootable medium. Write-locked Live SD WORM systems are the direct solid-state counterpart to live CDs, and can be booted natively in a media card slot or by using a USB adapter. Write-locked Live SD systems avoid excessive write cycles or corruption by ill-conditioned software, such as malware.

While a live OS typically does not alter any operating system or files already installed on a computer's secondary storage (such as data storage 408), many live OS include software mechanisms and utilities for altering the host computer's data stores, including installation of an operating system. This is important for the system management aspect of live OS, which can be useful for removing malware, for disk imaging, and for system recovery. Unless such software is used, at the end of a live OS session the computer remains as it was before. The live system is able to run without permanent installation by placing the files that normally would be stored on a hard drive into RAM, typically in a RAM disk. The computer must have sufficient RAM both to store these files and maintain normal operation.

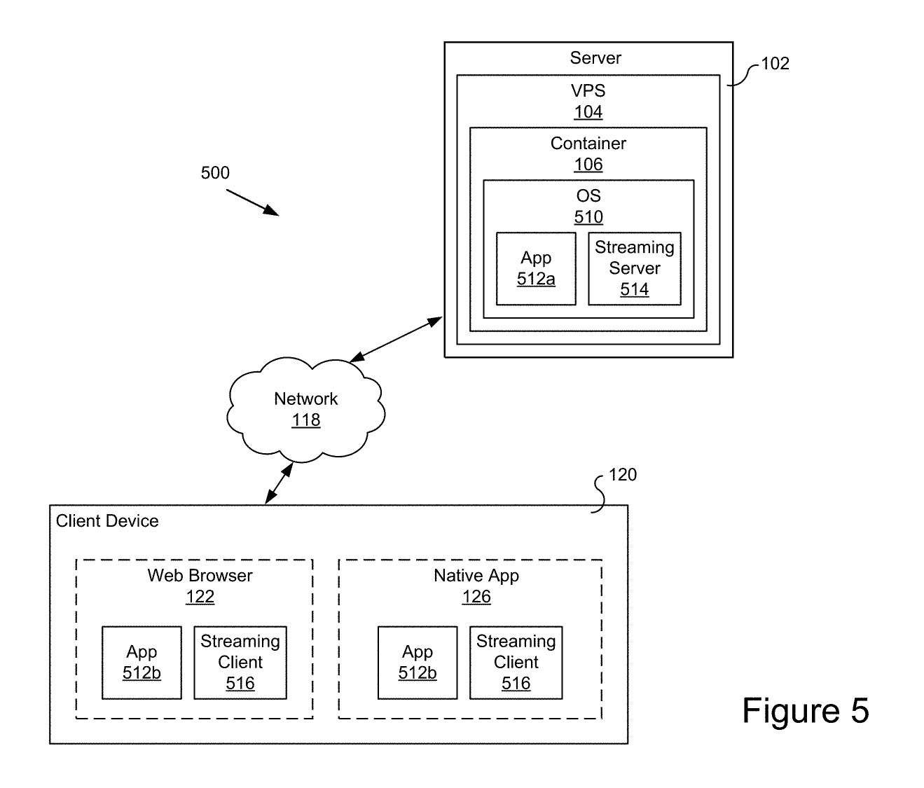

FIG. 5 is a block diagram illustrating an example system 500 for a collaborative platform providing an application streaming protocol. As described herein, the collaborative platform is a collection of software applications running on a server 102 and a client device 120. A virtual private server 104 is running on server 102 and includes a container in which applications and services run. In the example of FIG. 5, the operating system 510 running in container 106 represents any one of the cloud operating system 108, the mail operating system 110, the chat operating system 112, and the timeline operating system 116 depicted in the example of FIG. 1. In some embodiments, an application 512a is running on the operating system 510 in container 106. The operating system 510 includes a streaming server 514 configured to transmit an interface for application 512a to a streaming client 516 running on client device 120 such that application 512b is displayed to a user of client device 120. As depicted in the example of FIG. 5, application 512b is a replicated display of application 512a running on operating system 510. In some embodiments, as depicted in the example of FIG. 5, the steaming client is 516 running in a web browser 122 on the client device 120. In other embodiments, the streaming client 516 is running in a native application 126 on the client device 120. In either such embodiment, the streaming client 516 coordinates with the streaming server to render a display of the application 512a on the client device 120.

In some embodiments, streaming server 514 and streaming client 516 implement an architecture-independent system for remote graphical user interfaces and input device capabilities. For example, in one embodiment, the streaming server 514 and streaming client may implement a windows system based on an X type architecture. In another embodiment, the streaming server 514 and streaming client 516 may implement a windows system based on the Wayland architecture. In yet a further embodiment, the streaming server 514 and the streaming client 516 may implement a proprietary windows system. In another embodiment, the graphical user interface may be provided on the client device 120 by the server 102 using a virtual network computing arrangement.

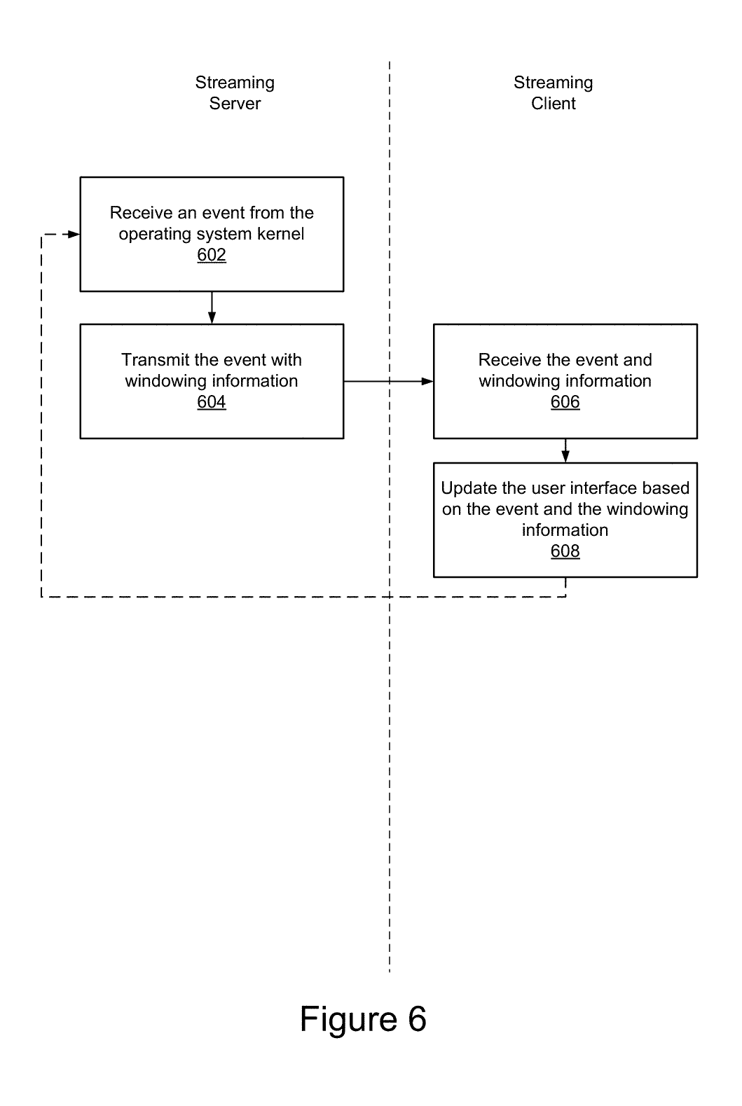

FIG. 6 is a flow diagram depicting an example communication between streaming server 514 and streaming client 516. At 602, the streaming server 514 receives an event from the operating system 510. For example, an input driver of the operating system detects an input from a user input device (e.g., a mouse or other pointer device, a keyboard, a tablet, a touchscreen, etc.) and the input driver transmits the event to the streaming server 514. In one embodiment, the input driver may be the evdev driver.

At 604, the streaming server 514 transmits the event with windowing information to the streaming client 516. In some embodiments, the windowing information includes screen coordinates—transformed into window-local coordinates. At 606, the streaming client 516 receives the event and the windowing information and at 608 updates the user interface based on the event and the windowing information.

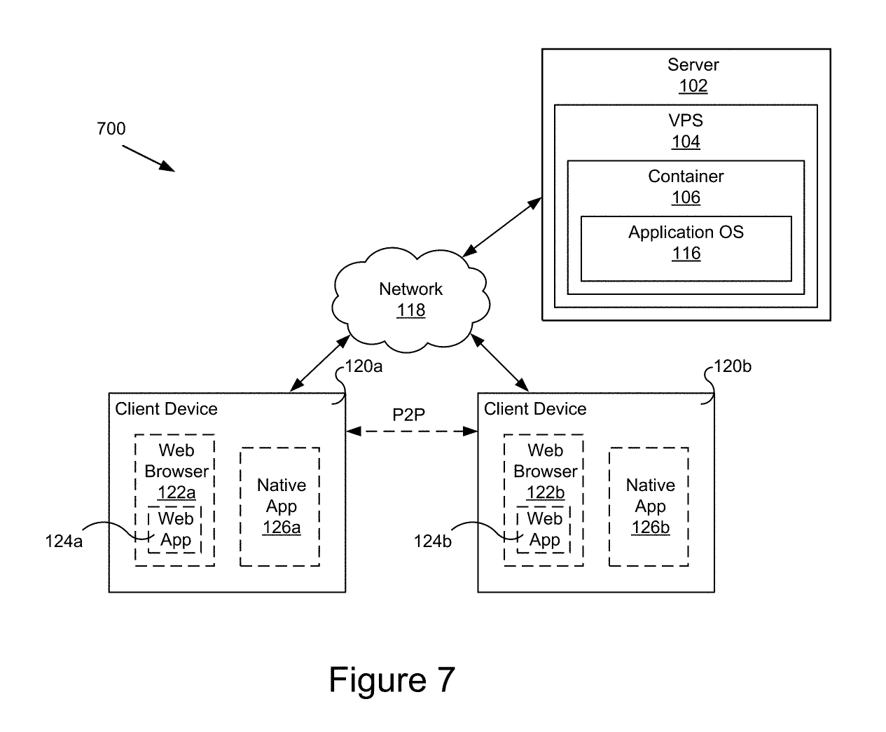

FIG. 7 is a block diagram illustrating an example system 700 depicting secure document sharing between client devices in a collaborative platform. As described herein, the collaborative platform is a collection of software applications running on a server 102 and a client device 120. A virtual private server 104 is running on server 102 and includes a container 106 in which applications and services run. In the example of FIG. 7, the application operating system 116 running in container 106 may provide, for example, a word processing application or a spreadsheet application, to the user of the client device 120a. The application may be displayed to the user of client device 120a via web application 124a in web browser 122a or in native application 126a.

In some embodiments, the user of client device 120a may wish to share the document with another user in the collaborative system, for example, a user of client device 120b. In some embodiments, rather than the second user accessing the document via the cloud storage system, the document is transmitted from client device 120a to client device 120b using a peer-to-peer connection.

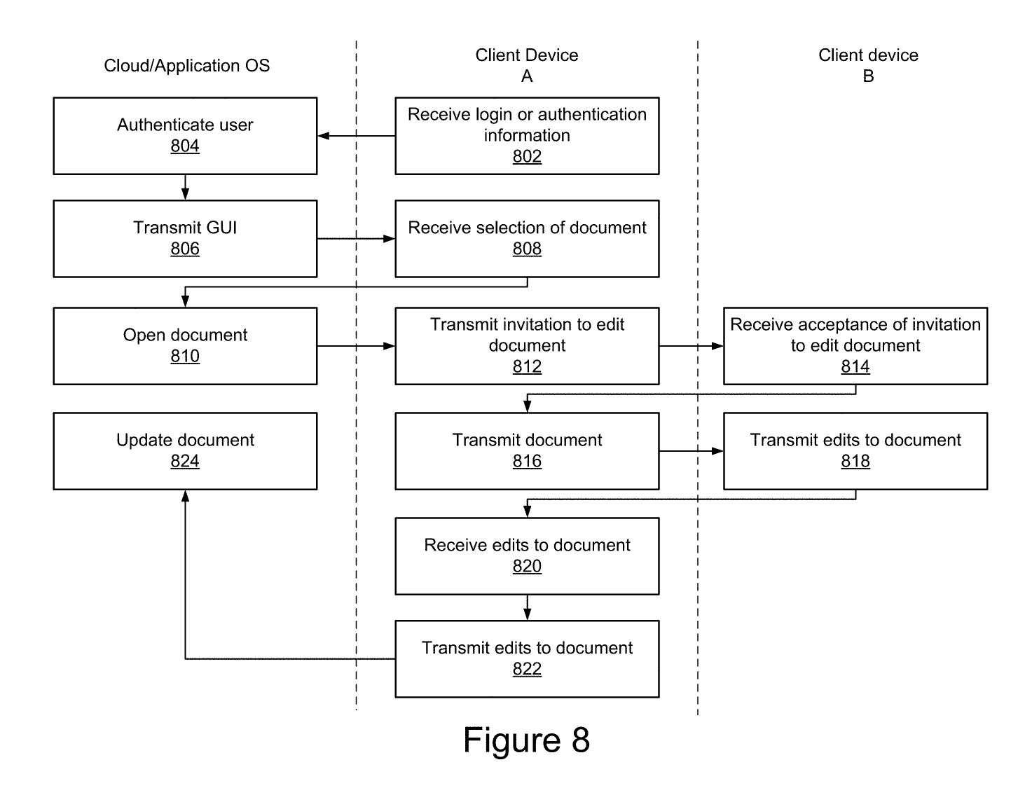

FIG. 8 is a flow diagram depicting an example flow of secure document sharing between client devices in a collaborative platform. At 802, client device 120a receives authentication information from a user, the authentication information for the user to access the collaborative platform. At 804, the cloud operating system 108 receives the authentication information from the client device 120a and verifies the authentication information. At 806, in response to the authentication information and selection of an application, the application operating system 116 transmits a graphical user interface to client device 120a where the user interface is displayed to the user in the web application 122a or native application 126a.

At 808, the client device 120a receives a selection of a document to edit using the application graphical user interface transmitted to client device 120a by application operating system 116. At 810, application operating system 116 opens the document and updates the user interface to display the document to the user. At 812, client device 120a transmits an invitation to client device 120b to edit the document. In one embodiment, the invitation is transmitted in response to the user selecting a share button on the user interface. In another embodiment, the document may be shared based on integration of the application operating system 116 with another operating system on server 102. For example, a user may send the document in a chat message or post the document to an event stream of a group to which the user of client device 120b belongs.

In any event, at 814, client device 120b receives the invitation, optionally notifies the user of the invitation, and receives, from the user, an acceptance of the invitation to edit the document. In response to receiving the acceptance of the invitation, client device 120b notifies client 120a and, at 816, client device 120a transmits the document to client device 120b. In one embodiment, client device 120a transmits the document to client device 120b using a peer-to-peer file sharing protocol. Client device 120b receives the document and transmits via the peer-to-peer connection, at 818, any edits made by the user of client device 120b to client device 120a. Similarly, any edits made by the user of client device 120a may be transmitted via the peer-to-peer connection to client device 120b. In some embodiments, edits made by each user may be displayed in a different color so that the users can differentiate between edits. At 820, client device 120a receives the edits to the document and transmits the edits, at 822, to the application operating system 116 where the edits are synchronized to the document stored on the cloud storage system.

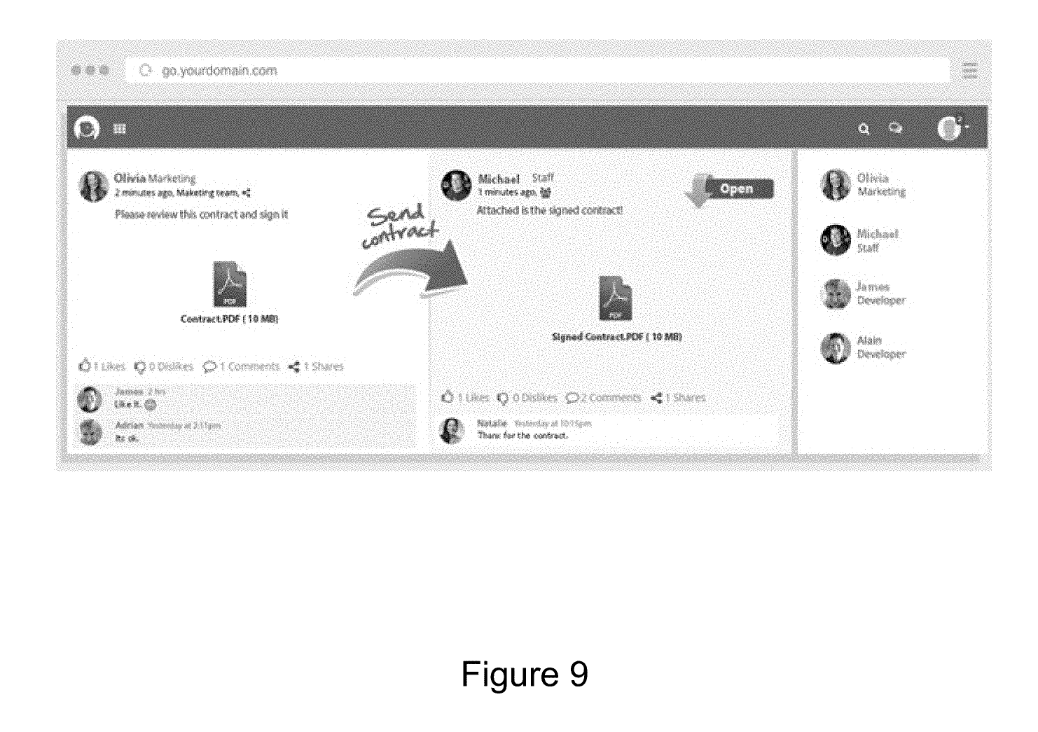

FIG. 9 is an example screenshot depicting an interface for sharing a document with another user via a peer-to-peer connection as described in the examples of FIGS. 7 and 8. As depicted in the example of FIG. 9, the file sharing is initiated by the user of client device 120a by sending the file as a message in chat a chat application provided by chat operating system 112a.

Systems and methods for distributing a data object in a distributed data storage system using a hierarchy rule that is generated based on a spreading policy and a set of tolerable failures specified by a user in absence of deployment information of the distributed data storage system has been described. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of data storage device including floppy disks, optical disks, CD-ROMs, and magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A system comprising:
a server having a memory and one or more processors configured to execute instructions stored on the memory, wherein the server is configured to perform operations comprising:
transmitting, by a cloud operating system running on the server, a first graphical user interface for display on a client device;
receiving authentication information, via the first graphical user interface, at the cloud operating system;
receiving a selection of a service, by the cloud operating system, from the client device via the first graphical user interface; and
transmitting, by a service operating system running on the server, a second graphical user interface for display on the client device.

2. The system of claim 1, wherein the cloud operating system and the service operating system are running on a virtual private server on the server.

3. The system of claim 2, wherein the cloud operating system and the service operating system are running in a container on the virtual private server on the server.

4. The system of claim 1, wherein the first graphical user interface and the second graphical user interface are configured to be operated as a web application in a web browser.

5. The system of claim 1, wherein the operations comprise transmitting, by the cloud operating system, the first graphical user interface to a streaming client via a streaming server.

6. The system of claim 1, wherein the operations comprise transmitting, by the cloud operating system, the first graphical user interface using a first protocol and transmitting, by the service operating system, the second graphical user interface using a second protocol.

7. The system of claim 1, wherein the service comprises one of a mail service, a chat service, a voice call service, a timeline service, an application streaming service, and a collaboration service.

8. A method comprising:
transmitting, by a cloud operating system running on a server, a first graphical user interface for display on a client device;
receiving authentication information, via the first graphical user interface, at the cloud operating system;
receiving a selection of a service, by the cloud operating system, from the client device via the first graphical user interface; and
transmitting, by a service operating system running on the server, a second graphical user interface for display on the client device.

9. The method of claim 8, wherein the cloud operating system and the service operating system are running on a virtual private server on the server.

10. The method of claim 9, wherein the cloud operating system and the service operating system are running in a container on the virtual private server on the server.

11. The method of claim 8, wherein the client device displays the first graphical user interface and the second graphical user interface as a web application in a web browser.

12. The method of claim 8, further comprising transmitting, by the cloud operating system, the first graphical user interface to a streaming client via a streaming server.

13. The method of claim 8, further comprising transmitting, by the cloud operating system, the first graphical user interface using a first protocol and the service operating system transmits the second graphical user interface using a second protocol.

14. The method of claim 8, wherein the service comprises one of a mail service, a chat service, a timeline service, an application streaming service, and a collaboration service.

15. A system comprising:
means for transmitting a first graphical user interface for display on a client device;
means for receiving authentication information;
means for receiving a selection of a service from the client device via the first graphical user interface; and
means for transmitting a second graphical user interface for display on the client device.

16. The system of claim 15, wherein the cloud operating system and the service operating system are running on a virtual private server on the server.

17. The system of claim 16, wherein the cloud operating system and the service operating system are running in a container on the virtual private server on the server.

18. The system of claim 15, wherein the first graphical user interface and the second graphical user interface are configured to be operated as a web application in a web browser.

19. The system of claim 15, wherein the operations comprise transmitting, by the cloud operating system, the first graphical user interface to a streaming client via a streaming server.

20. The system of claim 15, wherein the operations comprise transmitting, by the cloud operating system, the first graphical user interface using a first protocol and transmitting, by the service operating system, the second graphical user interface using a second protocol.
